(19) United States
(12) Patent Application Publication
(10) Pub. No.: US 2012/0115656 A1
(43) Pub. Date: May 10, 2012

(54) ELECTRIC-CONTROL BELT-TYPE VARIABLE-SPEED TRANSMISSION MECHANISM

(75) Inventors: Huan-Lung GU, Hsinchu (TW); Pin-Yung Chen, Hsinchu (TW); Chin-Hone Lin, Hsinchu (TW); Pan-Hsiang Hsieh, Hsinchu (TW); Shao-Yu Li, Hsinchu (TW)

(73) Assignee: INDUSTRIAL TECHNOLOGY RESEARCH INSTITUTE, Hsinchu (TW)

(21) Appl. No.: 12/966,018

(22) Filed: Dec. 13, 2010

(30) Foreign Application Priority Data
Nov. 4, 2010 (TW) 099137902

(51) Int. Cl. F16H 55/56

(52) U.S. Cl. 474/46; 474/8

(57) ABSTRACT

An electric-control belt-type continuous variable-speed transmission mechanism includes a driving-shaft, a driven-shaft, a driving-wheel, a driven-wheel, a transmission belt, a force-exerting device, an electric-control motor speed-adjusting device and an idle wheel. The electric-control motor speed-adjusting device operates along with the driving-wheel and the driven-wheel to dynamically control and adjust the overall configuration position of the transmission belt to thereby achieve effects of variable speeds, separation and restoration of dynamics. The idle wheel is rotatably disposed on the driving-shaft or the driven-shaft to axially support the transmission belt during the state of separate dynamics to prevent friction therebetween.

### BACKGROUND OF THE INVENTION

1. Field of the Invention

The present invention relates to electrical control belt type variable speed transmission mechanisms, and, more particularly, to a continuous variable speed transmission mechanism that prevents improper friction between surfaces of the transmission belt and the driving-shaft or driven-shaft and thus slows down wearing thereof.

2. Description of Related Art

In conventional belt-type continuous variable speed transmission mechanisms, the so-called centrifugal block and the rolling ball-plate speed adjusting mechanism are typically employed. For instance, Taiwanese Patent No. 1255242 disclosed a transmission system comprising a belt-type continuous variable speed transmission mechanism with a centrifugal block and a rolling ball-plate to control turning speeds of the engine and thus adjust the variable speed ratio of the transmission belt. A disadvantage of using this approach, however, is that the centrifugal block and rolling ball-plate are limited by the engine such that the variable speed ratios of the transmission belt cannot be flexibly adjusted to comply with different vehicle conditions, thus leading to the inability of the power system to function with optimal capability of dynamic power as required.

To resolve the foregoing problem, mechanisms of electrical motor belt-type continuous variable-speed transmissions become available, commonly known as the electrical control belt-type continuous variable speed transmission mechanism, such as the belt-type continuous variable speed transmission mechanism disclosed in Taiwanese Patent No. 1255242, in which an electric motor was used rather than the conventional centrifugal block and rolling ball-plate to achieve initiative adjustment of the interval between a fixed half-wheel and an unfixed half-wheel to thereby drive the transmission belt to adjust variable speed ratios. Nevertheless, such an electric control belt-type continuous variable speed transmission mechanism also has disadvantages of undesirable costly and large scale, in that it necessitates the use of a centrifugal clutch to separate and restore dynamics which inadvertently increases the cost and scale of the variable speed transmission mechanism.

Summarizing the above, it is desirable and highly beneficial to develop a novel electrical control belt-type continuous variable speed transmission mechanism that does not require the use of a centrifugal clutch for separating and restoring the power.

### SUMMARY OF THE INVENTION

In view of the drawbacks associated with the prior techniques, a primary objective of the invention is to provide an electrical control belt-type continuous variable speed transmission mechanism that does not require the use of a centrifugal clutch for the separation and restoration of power.

Another primary objective of the invention is to provide an electrical control belt-type continuous variable speed transmission mechanism that is cost-effective with a relatively desirable scale.

To achieve the above and other objectives, the present invention proposes an electric-control belt-type continuous variable-speed transmission mechanism, comprising: a driving-shaft and a driven-shaft; a driving-wheel comprising a driving fixed half wheel fixedly disposed on the driving shaft and a driving unfixed half wheel slidably disposed on the driving shaft; a driven-wheel comprising a driven fixed half wheel fixedly disposed on the driven shaft and a driving unfixed half wheel slidably disposed on the driven shaft, a transmission belt disposed on both the driving wheel and the driven wheel and comprising a driving end and a driven end; a force-exerting device for enabling the driven unfixed half wheel and the driven fixed half wheel to collectively clamp on the driven end of the transmission belt; an electric-control motor speed-adjusting device for enabling the driving unfixed half wheel and the driving fixed half wheel to collectively clamp on or completely release the driving end of the transmission belt according to a control signal; and an idle wheel rotatably disposed on the driving shaft at a position between the driving fixed half wheel and the driving unfixed half wheel to axially support the driving end of the transmission belt when it is completely released from the clamping of the driving unfixed half wheel and the driving fixed half wheel manipulated by the electric control motor speed-adjusting device.

Further, the present invention proposes an electric-control belt-type continuous variable-speed transmission mechanism, comprising: a driving-shaft and a driven-shaft; a driving-wheel comprising a driving fixed half wheel fixedly disposed on the driving shaft and a driving unfixed half wheel slidably disposed on the driving shaft; a driven-wheel comprising a driven fixed half wheel fixedly disposed on the driven shaft and a driving unfixed half wheel slidably disposed on the driven shaft, a transmission belt disposed on both the driving wheel and the driven wheel and comprising a driving end and a driven end; a force-exerting device for enabling the driving unfixed half wheel and the driving fixed half wheel to collectively clamp on the driving end of the transmission belt; an electric-control motor speed-adjusting device for enabling the driven unfixed half wheel and the driven fixed half wheel to collectively clamp on or completely release the driven end of the transmission belt according to a control signal; and an idle wheel rotatably disposed on the driven shaft at a position between the driven fixed half wheel and the driven unfixed half wheel to axially support the driven end of the transmission belt when it is completely released from the clamping of the driving unfixed half wheel and the driving fixed half wheel manipulated by the electric control motor speed-adjusting device.

In summary, the driving wheel and the driven wheel of the electric-control belt-type variable-speed transmission mechanism of the present invention are controlled by the force-exerting device and the electric-control motor, to dynamically control and adjust the overall configuration position of the transmission belt and thus achieve effects of variable speeds, separation and restoration of dynamics, and further, in the state of separate dynamics, the idle wheel rotatably disposed on the driving-shaft or driven-shaft can axially support the transmission belt to prevent improper friction between the driving shaft or the driven shaft.

### BRIEF DESCRIPTION OF THE DRAWINGS

The present invention can be more fully understood by reading the following detailed description of the preferred embodiments, with reference made to the accompanying drawings, wherein:

FIG. 1 is a cross-sectional view showing an increase in variable speed ratio range of the electric-control belt-type variable-speed transmission mechanism in accordance with the present invention;

FIG. 2 is a cross-sectional view showing a decrease in variable speed ratio range of the electric-control belt-type variable-speed transmission mechanism in accordance with the present invention; and

FIG. 3 is a cross-sectional view showing the separation of dynamics of the electric-control belt-type variable-speed transmission mechanism in accordance with the present invention.

### DETAILED DESCRIPTION OF THE PREFERRED EMBODIMENTS

The following illustrative embodiments are provided to illustrate the disclosure of the present invention, these and other advantages and effects can be understood by persons skilled in the art after reading the disclosure of this specification.

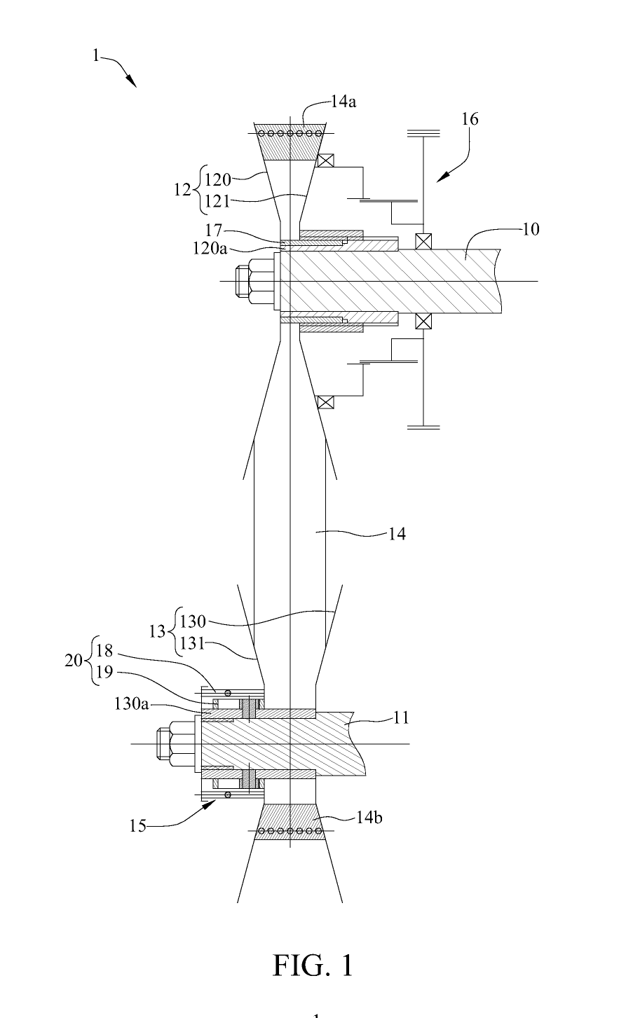

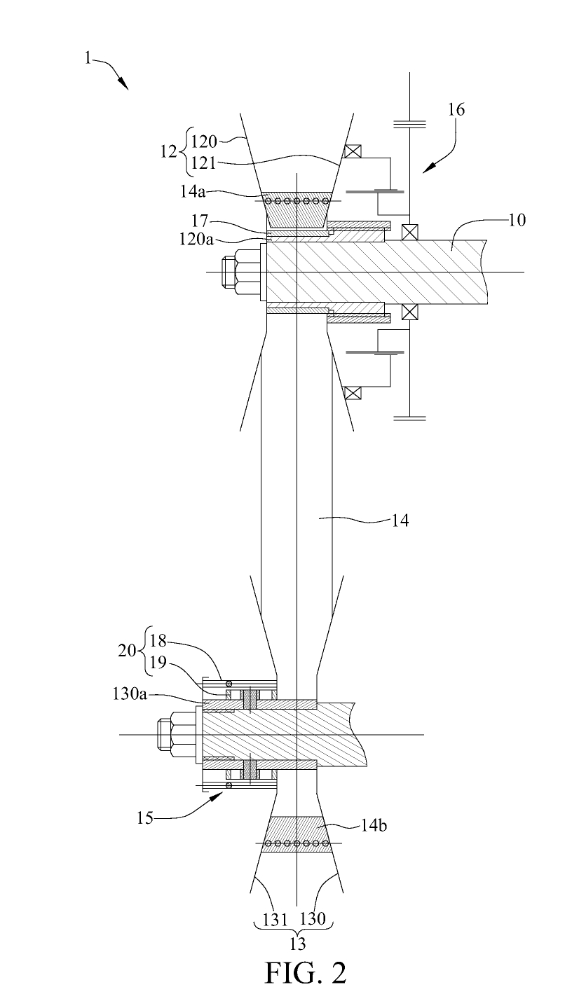

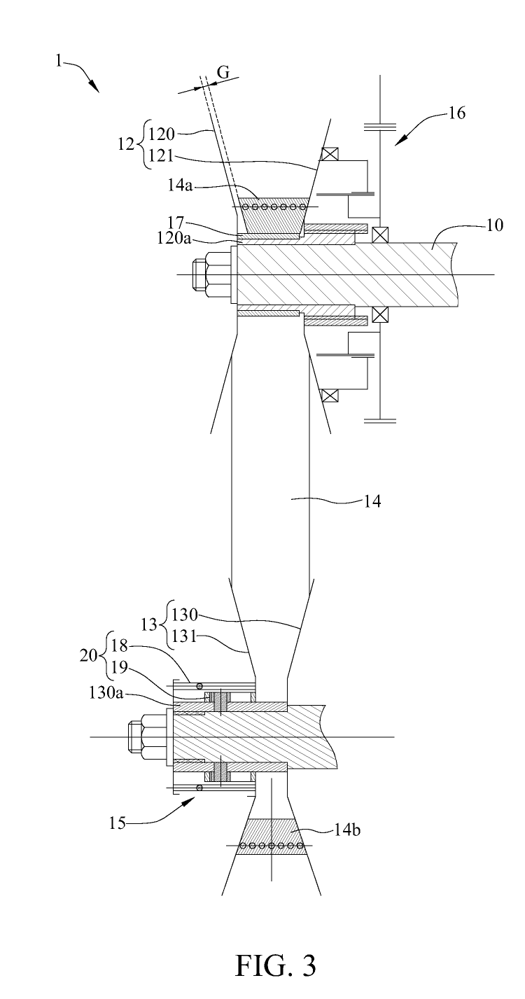

FIGS. 1, 2 and 3 illustrate the electric-control belt-type variable-speed transmission mechanism of the present invention. FIG. 1 is a cross-sectional view showing an increase in variable speed ratio range of the electric-control belt-type variable-speed transmission mechanism of the present invention; FIG. 2 is a cross-sectional view showing a decrease in variable speed ratio range of the electric-control belt-type variable-speed transmission mechanism of the present invention; and FIG. 3 is a cross-sectional view showing the separation of dynamics of the electric-control belt-type variable-speed transmission mechanism of the present invention.

As illustrated, the electric-control belt-type continuous variable-speed transmission mechanism 1 of the invention comprises a driving-shaft 10 for inputting rotational power, a driven-shaft 11 for outputting rotational power, a driving-wheel 12 disposed on the driving shaft 10, a driven-wheel 13 disposed on the driven shaft 11, a transmission belt 14 disposed on both the driving wheel 12 and the driven wheel 13, a force-exerting device 15 disposed beside the driven wheel 13, an electric-control motor speed-adjusting device 16 disposed beside the driving wheel 12, and an idle wheel 17 rotatably disposed on the driving shaft 10, wherein the idle wheel 17 may include, but is not limited to, an oil-contained distance ring or bushing structure.

The driving-wheel 12 comprises a driving fixed half wheel 120 fixedly disposed on the driving shaft 10 and a driving unfixed half wheel 121 slidably disposed on the driving shaft 10 and capable of axially rotating along the driving shaft 10.

The driven wheel 13 comprises a driven fixed half wheel 130 fixedly disposed on the driven shaft 11 and a driven unfixed half wheel 131 slidably disposed on the driven shaft 11 and capable of axially rotating along the driven shaft 11.

The transmission belt 14 is disposed on both the driving wheel 12 and the driven wheel 13 and includes a driving end 14a and a driven end 14b. The driving end 14a is disposed at a position between the driving fixed half wheel 120 and the driving unfixed half wheel 121. The inclined planes on two ends of the driving end 14a correspond to the respective inclined plane of the driving fixed half wheel 120 and the driving unfixed half wheel 121. The driven end 14b is disposed between the driven fixed half wheel 130 and the driven unfixed half wheel 131. The inclined planes on two ends of the driven end 14b respectively correspond to the inclined plane of the driven fixed half wheel 130 and the driven unfixed half wheel 131.

The force-exerting device 15 is adapted to enable the driven fixed half wheel 130 and the driven unfixed half wheel 131 to collectively clamp on the driven end 14b of the transmission belt 14. In one embodiment, the force-exerting device 15 is a torque cam spring set 20 that enables a compressive force to be continuously exerted toward the driven fixed half wheel 130 on the driven unfixed half wheel 131. The torque cam spring set 20 is constituted by a compressed spring 18 and a torque cam set 19, the torque cam spring set 20 being depicted and exemplified in an electric control belt-type continuous variable-speed system capable of generating tremendous compressive force. According to different design needs, the force-exerting device 15 may be an electric motor set capable of generating tremendous compressive force.

The electric-control motor speed-adjusting device 16 enables the driving unfixed half wheel 121 and the driven fixed half wheel 120 to collectively clamp on or completely release the driving end 14a of the transmission belt 14 according to the control signal. Specifically, the electric-control motor speed-adjusting device 16 enables the driving unfixed half wheel 121 to move axially to change the gap internal between the driving unfixed half wheel 121 and the driven fixed half wheel 120, such that the driving unfixed half wheel 121 and the driven fixed half wheel 120 are enabled to collectively clamp on or completely release the driving end 14a of the transmission belt 14.

The idle wheel 17 may include, but is not limited to, an oil-contained distance ring or bushing structure, and is rotatably disposed on the driving shaft 10 at a position between the driving fixed half wheel 120 and the driving unfixed half wheel 121 to axially support the driving end 14a of the transmission belt 14 when the transmission belt 14 is completely released from the clamping of the driving unfixed half wheel 121 and the driven fixed half wheel 120 as manipulated by the electric control motor speed-adjusting device 16.

In this embodiment, the wheel center region of the driving fixed half wheel 120 comprises a driving fixed half wheel cam 120a to be integrally disposed with the driving unfixed half wheel 121, and the wheel center region of the driven fixed half wheel 130 comprises a driving fixed half wheel cam 130a to be integrally disposed with the driven unfixed half wheel 131, thereby providing convenience and ease in assembling the driving fixed half wheel 120, the driving unfixed half wheel 121, the driven fixed half wheel 130, and the driven unfixed half wheel 131. Accordingly, the idle wheel 17 may be mounted on the driving fixed half wheel cam 120a to be rotatably disposed on the driving shaft 10. To satisfy different implementation requirements, users may opt to dispose the idle wheel 17 directly on the driving shaft 10 without installing the foregoing driving fixed half wheel cam 120a and the driving fixed half wheel cam 130a

Specifically, when receiving the control signal that indicates an ascending variable speed ratio, the electric-control motor speed-adjusting device 16 enables the driving unfixed half wheel 121 to move axially close to the driving fixed half wheel 120 so that the two driving half wheels 121 and 120 can collectively move the driving end 14a of the transmission belt 14 toward the direction away from the driving shaft 10, and concurrently, the overall position of the transmission belt 14 is pushed upward and since the driven fixed half wheel 130 and the driven unfixed half wheel 131 still collectively clamp on the driven end 14b of the transmission belt 14, the driven end 14b of the transmission belt 14 will be clamped by the driven fixed half wheel 130 and the driven unfixed half wheel 131 at a position close to the driven shaft 11, as depicted in FIG. 1.

On the other end, when receiving the control signal that indicates a descending variable speed ratio, the electric-control motor speed-adjusting device 16 enables the driving unfixed half wheel 121 to move axially away from the driving fixed half wheel 120 so that the two driving half wheels 121 and 120 collectively move the driving end 14a of the transmission belt 14 toward the direction close to the driving shaft 10, and concurrently, the overall position of the transmission belt is pushed downward and since the driven fixed half wheel 130 and the driven unfixed half wheel 131 still collectively clamp on the driven end 14b of the transmission belt 14, the driven end 14b of the transmission belt 14 will be clamped by the driven fixed half wheel 130 and the driven unfixed half wheel 131 at a position away from the driven shaft 11, as depicted in FIG. 2.

As illustrated in FIG. 3, when receiving the control signal that indicates separate dynamics, the electric-control motor speed-adjusting device 16 enables the driving unfixed half wheel 121 and the driving fixed half wheel 120 to completely release the driving end 14a of the transmission belt 14, and at this time, the distance between the driving unfixed half wheel 121 and the driving fixed half wheel 120 is greater than the width of the driving end 14a of the transmission belt 14 and a gap G emerges therebetween so that the driving end 14a of the transmission belt 14 begins to move downwardly, and since the driven fixed half wheel 130 and the driven unfixed half wheel 131 still collectively clamp on the driven end 14b of the transmission belt 14, the driven end 14b thereof gradually moves toward outer edges of the driven fixed half wheel 130 and the driven unfixed half wheel 131, while the idle wheel 17 starts to axially support the driving end 14a of the transmission belt 14 by rotation.

When the driving unfixed half wheel 121 and the driven fixed half wheel 120 completely release the driving end 14a of the transmission belt 14, the transmission belt 14 ceases to transmit dynamics of the driving shaft 10 to the driven shaft 11 and thus is in the state of separate dynamics, but since the driven unfixed half wheel 131 still continues to push the driven end 14b of the transmission belt 14 that makes the driving end 14a to downwardly be in contact with the idle wheel 17, the idle wheel 17 then begins to absorb residual stress of the transmission belt 14 by rotation and thus prevents improper friction between the driving end 14a of the transmission belt 14 and the driving shaft 10. In other words, without the idle wheel 17 the driving end 14a of the transmission belt 14 and the driving shaft 10 will suffer from improper friction therebetween in the state of separate dynamics.

When receiving the control signal that indicates restoring dynamics, the electric-control motor speed-adjusting device 16 enables the driving unfixed half wheel 121 to move axially toward the driving unfixed half wheel 121 that cancels the gap internal G therebetween such that the driving unfixed half wheel 121 and the driven fixed half wheel 120 are enabled to collectively clamp on the driving end 14a, thereby allowing the transmission belt 14 to transmit dynamics of the driving shaft 10 to the driven shaft 11 to achieve restoration of dynamics.

Note that the positions of the force-exerting device, the electric-control motor speed-adjusting device and the idle wheel can be flexibly altered as required and desired as the switching positions in FIGS. 1 to 3. For instance, in another aspect of the present embodiment, the force-exerting device may be disposed beside the driving wheel to enable the driving unfixed half wheel and the driven fixed half wheel to collectively clamp on the driving end of the transmission belt; the electric control motor speed-adjusting device may be disposed at a position beside the driven wheel to enable the driving unfixed half wheel and the driven fixed half wheel to collectively clamp or release the driven end of the transmission belt; and the idle wheel may be rotatably disposed on the driving-shaft or the driven-shaft at a position between the driving unfixed half wheel and the driven fixed half wheel to axially support the driven end of the transmission belt when it is completely released from the clamping of the driving unfixed half wheel and the driven fixed half wheel manipulated by the electric-control motor speed-adjusting device.

Accordingly, upon receiving the control signal that indicates the ascending variable speed ratio, the electric-control motor speed-adjusting device enables the driven fixed half wheel to move axially away from the driven fixed half wheel, and at this time, since the driving fixed half wheel and the driving unfixed half wheel still collectively clamp on the driving end of the transmission belt, the driving fixed half wheel and the driving unfixed half wheel will collectively move the driving end of the transmission belt away from the driving shaft, while the driven fixed half wheel and the driven unfixed half wheel will collectively move the driven end of the transmission belt close to the driven shaft.

On the other end, upon receiving the control signal that indicates the descending variable speed ratio, the electric-control motor speed-adjusting device enables the driven unfixed half wheel to move axially close to the driven fixed half wheel so that the two driven half wheels can collectively move the driven end of the transmission belt away from the driven shaft, and at this time, since the driving fixed half wheel and the driving unfixed half wheel still collectively clamp on the driving end of the transmission belt, the driving fixed half wheel and the driving unfixed half wheel will collectively move the driving end of the transmission belt close to the driving shaft.

Further, when receiving the control signal that indicates the separate dynamics, the electric-control motor speed-adjusting device enables the driven unfixed half wheel and the driven fixed half wheel to completely release the driven end of the transmission belt, and at this time, the distance between the driven unfixed half wheel and the driven fixed half wheel is greater than the width of the driven end of the transmission belt that enables the idle wheel to axially support the driven end of the transmission belt and thus separate dynamics. Specifically, during the state of separate dynamics, since the driving fixed half wheel and the driving unfixed half wheel still collectively clamp on the driving end of the transmission belt, the driving fixed half wheel and the driving unfixed half wheel will collectively move the driving end away from the driving shaft, that is, the driving end is gradually clamped and moved to between the outer edges of the driving fixed half wheel and the driving unfixed half wheel, and the driven end of the transmission belt correspondingly moves upward and in contact with the idle wheel, causing the idle wheel to rotate and thus absorb residual stress of the transmission belt to prevent improper friction between the driven shaft and the transmission belt.

When receiving the control signal that indicates the restoring dynamics, the electric-control motor speed-adjusting device enables the driven unfixed half wheel and the driven fixed half wheel to collectively clamp on the driven end of the transmission belt to achieve restoration of dynamics.

Summarizing the above, the electric-control belt-type continuous variable-speed transmission mechanism of the present invention controls the driving and driven wheels by means of the force-exerting device and the electric control motor so as to dynamically control and adjust the overall configuration position of the transmission belt and thereby achieve effects of variable speeds, separate dynamics and restoring dynamics. Further, during the state of separate dynamics, the idle wheel rotatably disposed on the driving-shaft or the driven-shaft can axially support the transmission belt and prevent the improper friction therebetween.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An electric-control belt-type continuous variable-speed transmission mechanism, comprising:
a driving-shaft and a driven-shaft;
a driving-wheel comprising a driving fixed half wheel fixedly disposed on the driving shaft and a driving unfixed half wheel slidably disposed on the driving shaft;
a driven-wheel comprising a driven fixed half wheel fixedly disposed on the driven shaft and a driving unfixed half wheel slidably disposed on the driven shaft;
a transmission belt disposed on both the driving wheel and the driven wheel and comprising a driving end and a driven end;
a force-exerting device for allowing the driven unfixed half wheel and the driven fixed half wheel to collectively clamp on the driven end of the transmission belt;
an electric-control motor speed-adjusting device for allowing the driving unfixed half wheel and the driving fixed half wheel to collectively clamp on or completely release the driving end of the transmission belt according to a control signal; and
an idle wheel rotatably disposed on the driving shaft at a position between the driving fixed half wheel and the driving unfixed half wheel to axially support the driving end of the transmission belt when the transmission belt is completely released from the clamping of the driving unfixed half wheel and the driving fixed half wheel manipulated by the electric-control motor speed-adjusting device.

2. The electric-control belt-type continuous variable-speed transmission mechanism as claimed in claim 1, wherein the driving fixed half wheel comprises a driving fixed half wheel cam disposed in a wheel center region of the driving fixed half wheel to be integrally disposed with the driving unfixed half wheel, the driven fixed half wheel comprises a driving fixed half wheel cam disposed in a wheel center region of the driven fixed half wheel to be integrally disposed with the driven unfixed half wheel, and the idle wheel is mounted on the driving fixed half wheel cam to be rotatably disposed on the driving shaft.

3. The electric-control belt-type continuous variable-speed transmission mechanism as claimed in claim 1, wherein the force-exerting device comprises a torque cam spring set or an electric motor set.

4. The electric-control belt-type continuous variable-speed transmission mechanism as claimed in claim 1, wherein upon receiving the control signal that indicates an ascending a variable speed ratio, the electric-control motor speed-adjusting device enables the driving fixed half wheel to move axially close to the driving fixed half wheel, thereby allowing the driving fixed half wheel and the driving unfixed half wheel to collectively move the driving end of the transmission belt away from the driving shaft, while the driven fixed half wheel and the driven unfixed half wheel collectively move the driven end of the transmission belt toward the direction close to the driven shaft.

5. The electric-control belt-type continuous variable-speed transmission mechanism as claimed in claim 1, wherein upon receiving the control signal that indicates a descending variable speed ratio, the electric-control motor speed-adjusting device enables the driving unfixed half wheel to move axially away from the driving fixed half wheel, thereby allowing the two driving half wheels to collectively move the driving end of the transmission belt close to the driving shaft, while the driven fixed half wheel and the driven unfixed half wheel collectively move the driven end of the transmission belt away from the driven shaft.

6. The electric-control belt-type continuous variable-speed transmission mechanism as claimed in claim 1, wherein upon receiving the control signal that indicates separate dynamics, the electric-control motor speed-adjusting device enables the driving unfixed half wheel and the driving fixed half wheel to completely release the driving end of the transmission belt, such that the driving unfixed half wheel and the driving fixed half wheel are spaced at a distance greater than a width of the driving end of the transmission belt that enables the idle wheel to axially support the driving end of the transmission belt and thus separate dynamics, while at this time the driven fixed half wheel and the driven unfixed half wheel collectively clamp on the driven end of the transmission belt at a position between outer edges of the driven fixed half wheel and the driven unfixed half wheel.

7. The electric-control belt-type continuous variable-speed transmission mechanism as claimed in claim 6, wherein upon receiving the control signal that indicates restoring dynamics, the electric-control motor speed-adjusting device enables the driving unfixed half wheel and the driving fixed half wheel to collectively clamp on the driving end of the transmission belt to achieve restoration of dynamics

8. The electric-control belt-type continuous variable-speed transmission mechanism as claimed in claim 1, wherein the idle wheel includes an oil-contained bushing structure or distance ring.

9. An electric-control belt-type continuous variable-speed transmission mechanism, comprising:
a driving-shaft and a driven-shaft;
a driving-wheel comprising a driving fixed half wheel fixedly disposed on the driving shaft and a driving unfixed half wheel slidably disposed on the driving shaft;
a driven-wheel comprising a driven fixed half wheel fixedly disposed on the driven shaft and a driving unfixed half wheel slidably disposed on the driven shaft;
a transmission belt disposed on both the driving wheel and the driven wheel and comprising a driving end and a driven end;
a force-exerting device for allowing the driving unfixed half wheel and the driving fixed half wheel to collectively clamp on the driving end of the transmission belt;
an electric-control motor speed-adjusting device for allowing the driven unfixed half wheel and the driven fixed half wheel to collectively clamp on or completely release the driven end of the transmission belt according to a control signal; and
an idle wheel rotatably disposed on the driven shaft at a position between the driven fixed half wheel and the driven unfixed half wheel to axially support the driven end of the transmission belt when the transmission belt is completely released from the clamping of the driving unfixed half wheel and the driving fixed half wheel manipulated by the electric control motor speed-adjusting device.

10. The electric-control belt-type continuous variable-speed transmission mechanism as claimed in claim 9, wherein the driving fixed half wheel comprises a driving fixed half wheel cam disposed in a wheel center region of the driving fixed half wheel to be integrally disposed with the driving unfixed half wheel, the driven fixed half wheel comprises a driving fixed half wheel cam disposed in a wheel center region of the driven fixed half wheel to be integrally disposed with the driven unfixed half wheel, and the idle wheel is mounted on the driven fixed half wheel cam to be rotatably disposed on the driven shaft.

11. The electric-control belt-type continuous variable-speed transmission mechanism as claimed in claim 9, wherein the force-exerting device comprises a torque cam spring set or an electric motor set.

12. The electric-control belt-type continuous variable-speed transmission mechanism as claimed in claim 9, wherein upon receiving the control signal that indicates an ascending variable speed ratio, the electric-control motor speed-adjusting device enables the driven fixed half wheel to move axially away from the driven fixed half wheel, thereby allowing the driven fixed half wheel and the driven unfixed half wheel to collectively move the driven end of the transmission belt toward a direction of the driven shaft, while the driving fixed half wheel and the driving unfixed half wheel collectively move the driving end of the transmission belt away from the driven shaft.

13. The electric-control belt-type continuous variable-speed transmission mechanism as claimed in claim 9, wherein upon receiving the control signal that indicates a descending variable speed ratio, the electric-control motor speed-adjusting device enables the driven unfixed half wheel to move axially close to the driven fixed half wheel, thereby allowing the two driven half wheels to collectively move the driven end of the transmission belt away from the driving shaft, while the driving fixed half wheel and the driving unfixed half wheel collectively move the driving end of the transmission belt close to the driving shaft.

14. The electric-control belt-type continuous variable-speed transmission mechanism as claimed in claim 9, wherein upon receiving the control signal that indicates separate dynamics, the electric-control motor speed-adjusting device enables the driven unfixed half wheel and the driven fixed half wheel to completely release the driven end of the transmission belt, such that the driven unfixed half wheel and the driven fixed half wheel are spaced at a distance greater than a width of the driven end of the transmission belt that enables the idle wheel to axially support the driven end of the transmission belt and thus separate dynamics, while at this time the driving fixed half wheel and the driving unfixed half wheel collectively clamp on the driving end of the transmission belt at a position between outer edges of the driving fixed half wheel and the driving unfixed half wheel.

15. The electric-control belt-type continuous variable-speed transmission mechanism as claimed in claim 14, wherein upon receiving the control signal that indicates restoring dynamics, the electric-control motor speed-adjusting device enables the driven unfixed half wheel and the driven fixed half wheel to collectively clamp on the driven end of the transmission belt to achieve restoration of dynamics.

16. The electric-control belt-type continuous variable-speed transmission mechanism as claimed in claim 9, wherein the idle wheel includes an oil-contained bushing structure or distance ring.
